(19) United States
(12) Patent Application Publication
(10) Pub. No.: US 2023/0011511 A1
(43) Pub. Date: Jan. 12, 2023

(54) Pre-Processing Method

(71) Applicant: Nippon Telegraph and Telephone Corporation, Tokyo (JP)

(72) Inventors: Azusa Ishii, Tokyo (JP); Takashi Miwa, Tokyo (JP); Masamitsu Watanabe, Tokyo (JP); Soichi Oka, Tokyo (JP)

(21) Appl. No.: 17/779,877

(22) PCT Filed: Dec. 5, 2019
(86) PCT No.: PCT/JP2019/047635

§ 371 Date: May 25, 2022

(51) Int. Cl. G01N 1/40; G01N 30/14

(52) U.S. Cl. CPC G01N 1/4005; G01N 30/14; G01N 2030/146

(57) ABSTRACT

In a pretreatment method, in a first step, a sample is dissolved in 1,1,1,3,3,3-hexafluoro-2-propanol to prepare a first solution. In a second step, an organic base that has a lower boiling point than that of HFIP is added to the first solution to prepare a second solution. In a third step, the second solution is heated to obtain a substance in which an anhydrous oxide structure in the sample has been decomposed. In a fourth step, chloroform is added to the second solution to prepare a third solution.

### TECHNICAL FIELD

The present invention relates to a pretreatment method and relates to a method for pretreating a sample consisting of polyester or a polyester decomposition product before carrying out size exclusion chromatography of the sample.

### BACKGROUND ART

Polyester having thermoplasticity (thermoplastic polyester) has both strength and flexibility and is thus used as engineering plastic for various purposes. For example, the thermoplastic polyester polyethylene terephthalate (PET) is used in films, fibers, bottles for beverages, etc., some of which are also recycled. The deterioration of the thermoplastic polyester progresses due to heat or light. It is industrially important to understand the state of this deterioration. The understanding of the state of the deterioration mentioned above can be carried out, for example, by the measurement of a molecular weight distribution.

The molecular chain scission reaction and cross-linking reaction of the thermoplastic polyester progress due to heat or light. The progression of molecular chain scission or the formation of a cross-linked structure largely influences the mechanical characteristics, such as strength, of the thermoplastic polyester and causes reduction in performance such as reduction in strength. This leads to the deterioration of the thermoplastic polyester. Thus, the progression of molecular chain scission or the formation of a cross-linked structure mentioned above can be understood by the measurement of a molecular weight distribution, and the state of the deterioration of the thermoplastic polyester can thereby be evaluated. This measurement of a molecular weight distribution employs size exclusion chromatography (see Non-Patent Literature 1).

The size exclusion chromatography is a method of separating or purifying an analysis sample by exploiting different times at which molecules pass through a column depending on their sizes. For analysis using the size exclusion chromatography, as in other chromatography techniques, a detector is placed in the discharge destination of a column, and a substance that has passed through the column is detected and output as signals (chromatogram) corresponding to the concentration of the substance in the detector.

In this kind of analysis, insoluble components are removed from an analysis sample by filtration through a filter at the stage of preparation of the analysis sample in order to prevent the clogging of a column. In the case of thermoplastic polyester, a solution of 1,1,1,3,3,3-hexafluoro-2-propanol (HFIP) supplemented with approximately 1 to 10 mmol/L of a salt such as sodium trifluoroacetate is generally used as an eluent to prepare an analysis sample. In the preparation of the analysis sample, a thermoplastic polyester sample is dissolved in the eluent mentioned above, left standing at room temperature for several hours, and then filtered through a filter (pore size: e.g., 0.2 µm) for the removal of insoluble components. The measurement is carried out by using this filtrate as an analysis sample.

A deteriorated thermoplastic polyester sample rich in cross-linked structure contains insoluble components that cannot be dissolved in an eluent. These insoluble components are removed by the filtration mentioned above and are no longer contained in an analysis sample. Thus, the insoluble components mentioned above are not included in results of measuring a molecular weight distribution. However, for understanding the state of the deterioration of thermoplastic polyester, it is important to analyze (evaluate) a molecular weight in a state also including the insoluble components mentioned above.

In order to gain information on molecular weight as to components that cannot be dissolved in an eluent, it is possible to carry out size exclusion chromatography by decomposing a particular molecular structure contained in insoluble components and dissolving the resultant in an eluent in pretreatment. For this pretreatment, it is desired that molecular structures contained in repeat units of a molecular chain, such as ester bonds in polyester should not be decomposed.

As mentioned above, molecular chain scission is an index for deterioration. If a molecular chain is cleaved by decomposing a portion of molecular structures contained in repeat units of the molecular chain, whether this is due to pretreatment or due to deterioration cannot be determined. Thus, measurement results are difficult to interpret. Furthermore, it is not easy to control the degree of progression of decomposition of molecular structures in repeat units of a molecular chain. Thus, reproducibility is difficult to secure.

As well known, thermoplastic polyester deteriorated due to light or heat is in a state containing an acid anhydride structure. Provided that this anhydrous oxide can be selectively decomposed without decomposing ester bonds, the problems mentioned above are solved. Since the anhydrous oxide is more susceptible to decomposition with a base than ester bonds, it is considered that the acid anhydride structure can be decomposed, for example, by dissolving a thermoplastic polyester sample in HFIP and adding an organic base thereto.

### CITATION LIST

### Non-Patent Literature

Non-Patent Literature 1: B. Trathnigg, “Size-exclusion Chromatography of Polymers”, Encyclopedia of Analytical Chemistry, R. A. Meyers (Ed.), pp. 8008-8034, John Wiley & Sons Ltd, Chichester, 2000.

### SUMMARY OF THE INVENTION

### Technical Problem

As a result of examining whether the pretreatment for the size exclusion chromatography of thermoplastic polyester mentioned above decomposes an acid anhydride structure without decomposing ester bonds, it has been found that ester bonds are also decomposed. When deteriorated thermoplastic polyester is used as a sample and dissolved in HFIP containing an organic base, the anhydrous oxide structure can be decomposed. In this respect, the decomposition of ester bonds is supposed to rarely proceed by properly setting the amount of the organic base added and avoiding heating for a long time.

In this context, the size exclusion chromatography is carried out, as mentioned above, by dissolving a sample in HFIP containing a proper amount of an organic base, heating the solution for a proper time so that an acid anhydride structure is decomposed, then removing the solvent from this solution to obtain a solid sample, and dissolving the obtained solid in an eluent. As a result of analyzing the obtained solid to be dissolved in this eluent for the state of ester bonds, it has been confirmed that ester bonds supposed to be not decomposed by the pretreatment using the organic base mentioned above were decomposed. Thus, a problem of the pretreatment merely using an organic base as mentioned above is the decomposition of ester bonds.

The present invention has been made in order to solve the problems as mentioned above. An object of the present invention is to suppress the decomposition of ester bonds in the pretreatment of a sample consisting of polyester or a polyester decomposition product for carrying out size exclusion chromatography.

### Means for Solving the Problem

The pretreatment method according to the present invention is a method for pretreating a sample consisting of polyester or a polyester decomposition product before carrying out size exclusion chromatography of the sample, comprising: a first step of dissolving the sample in 1,1,1,3,3,3-hexafluoro-2-propanol to prepare a first solution; a second step of adding an organic base that has a lower boiling point than that of 1,1,1,3,3,3-hexafluoro-2-propanol to the first solution to prepare a second solution; a third step of heating the second solution to obtain a substance in which an anhydrous oxide structure in the sample has been decomposed; a fourth step of, following the third step, adding chloroform to the second solution to prepare a third solution; and a fifth step of removing the solvent from the third solution to obtain a solid sample consisting of the substance.

### EFFECTS OF THE INVENTION

As described above, according to the present invention, the decomposition of ester bonds can be suppressed in the pretreatment of a sample consisting of polyester or a polyester decomposition product for carrying out size exclusion chromatography, because an organic base that has a lower boiling point than that of 1,1,1,3,3,3-hexafluoro-2-propanol is added.

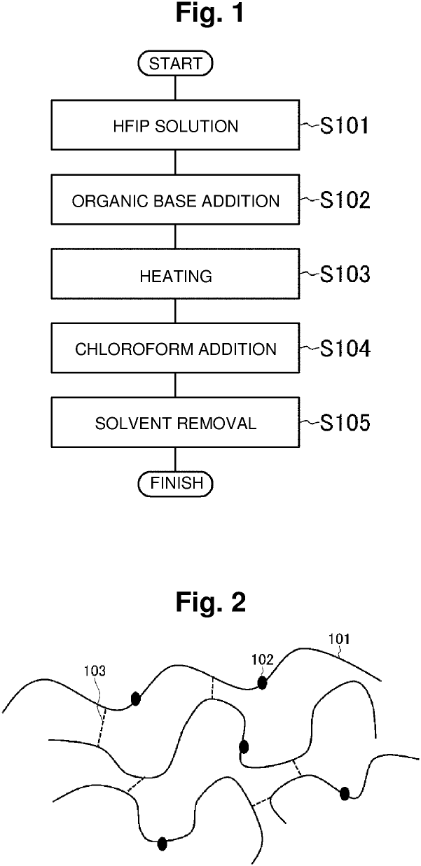

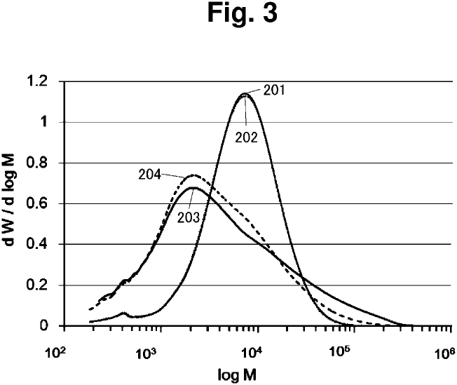

### BRIEF DESCRIPTION OF DRAWINGS

[FIG. 1] FIG. 1 is a flow chart for illustrating a pretreatment method according to an embodiment of the present invention.

[FIG. 2] FIG. 2 is a configurational diagram showing the molecular structure of deteriorated polyethylene terephthalate.

[FIG. 3] FIG. 3 is a characteristic diagram showing results of measurement by size exclusion chromatography to which the present invention was applied.

### DESCRIPTION OF EMBODIMENTS

Hereinafter, a pretreatment method according to an embodiment of the present invention will be described with reference to FIG. 1. This pretreatment method relates to the pretreatment of a sample consisting of polyester or a polyester decomposition product (deteriorated thermoplastic polyester) before carrying out size exclusion chromatography of the sample. The thermoplastic polyester is polyethylene terephthalate, polypropylene terephthalate, polybutylene terephthalate, polyneopentyl terephthalate, polycyclohexyl terephthalate, poly-dicyclohexylmethyl terephthalate, polyethylene isophthalate, polypropylene isophthalate, polybutylene isophthalate, polyneopentyl isophthalate, polyethylene naphthalate, polybutylene naphthalate, or the like. Also, copolymers of these thermoplastic polyesters are included therein. Further, copolymers of polyamide (nylon 6, nylon 11, nylon 12, and nylon 66) or polyacetal and thermoplastic polyester are also included therein.

First, in first step S101, the sample is dissolved in 1,1,1,3,3,3-hexafluoro-2-propanol (HFIP) to prepare a first solution.

Next, in second step S102, an organic base that has a lower boiling point than that of HFIP is added to the first solution to prepare a second solution. The concentration of the organic base in the second solution is larger than 0.05 [mmol/L] and less than 0.4 [mmol/L]. The organic base having a lower boiling point than that of HFIP and chloroform can be used. For example, ethylamine, diethylamine, n-propylamine, i-propylamine (isopropylamine), t-butylamine, and dimethylethylamine can be used as the organic base having a lower boiling point than that of HFIP and chloroform.

Next, in third step S103, the second solution is heated to obtain a substance in which an anhydrous oxide structure in the sample has been decomposed. This substance is dissolved in the second solution at this stage.

Subsequently, in fourth step S104, chloroform is added to the second solution to prepare a third solution. The ratio of amount V [mL] of chloroform to amount “a” [ml] of HFIP in the third solution is 0 < V/a.

Then, in fifth step S105, the solvent is removed from the third solution to obtain a solid sample consisting of the substance in which an anhydrous oxide structure in the sample has been decomposed. The solvent can be vaporized by heating and thereby removed, for example. Alternatively, the solvent may be removed from the third solution by concentration under reduced pressure to obtain a solid sample.

The solid sample is thus obtained, and for subsequent size exclusion chromatography, the obtained solid sample is dissolved in a solvent (eluent) for size exclusion chromatography (sixth step).

Here, the deterioration of thermoplastic polyester will be described. As the deterioration of thermoplastic polyester progresses due to heat (heating) or light (light reception), its molecular chain scission reaction and cross-linking reaction progress, causing reduction in performance such as deterioration in strength. The course of reaction leading to molecular chain scission includes a pathway leading to molecular chain scission by only light, such as “Norrish II” reaction.

A molecular structure represented by the chemical structural formula (1) given below is converted to a molecular structure represented by the chemical structural formula (2) through photooxidation reaction and then converted to a molecular structure represented by the chemical structural formula (3) through ambient oxygen to form an acid anhydride structure which is a molecular structure weak in water. Then, the pathway leads to molecular chain scission as represented by the chemical structural formula (4) through hydrolysis.

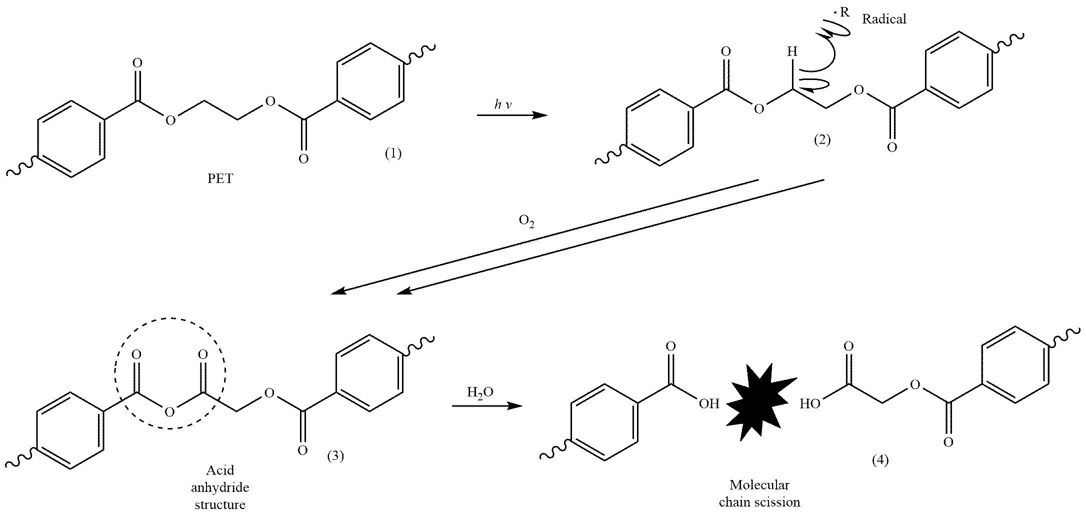

In the course of reaction to form a cross-linked structure, a molecular structure represented by the chemical structural formula (5) given below is converted to a molecular structure represented by the chemical structural formula (7) through the withdrawal of a hydrogen radical by radical R· as represented by the chemical structural formula (6), and two molecular structures of the chemical structural formula (7) form a cross-linked structure through radicals to yield a molecular structure represented by the chemical structural formula (8). Such a course of reaction increases the number of cross-linked structures so that the thermoplastic polyester is insolubilized.

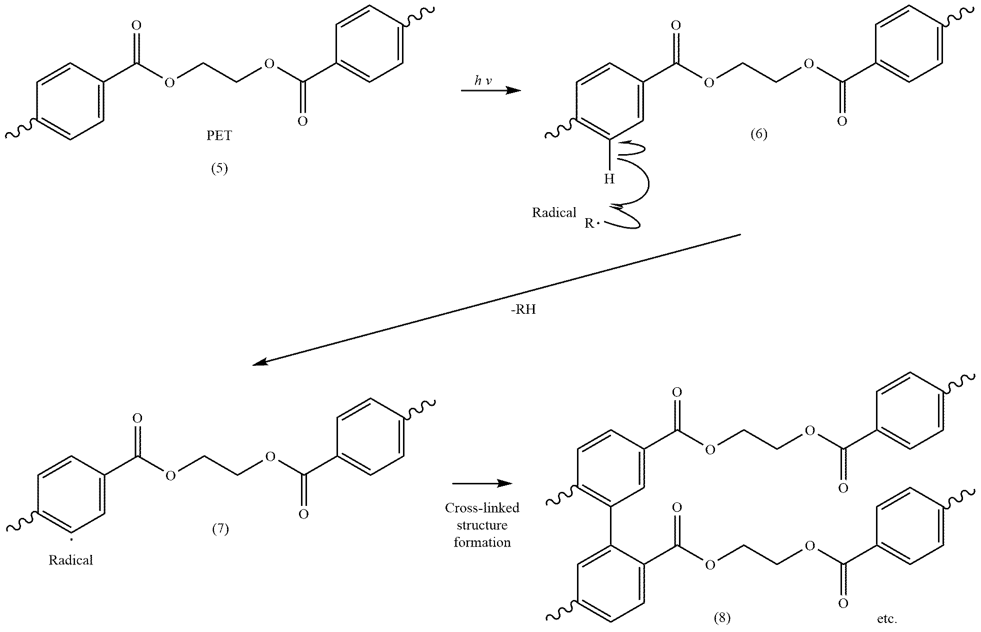

For example, when the thermoplastic polyester polyethylene terephthalate (PET) is deteriorated, as shown in FIG. 2, acid anhydride structure 102 is formed halfway molecular chain 101. Also, cross-linked structure 103 which links two adjacent molecular chains 101 is formed, for example. The formation of such a network structure based on the cross-linked structure 103 involving the acid anhydride structure 102 is responsible for insolubilization. In such a molecular structure ascribable to deterioration, the decomposition of the acid anhydride structure 102 renders the network structure sparse, causing solubilization.

Hereinafter, the present invention will be described in more detail with reference to experimental results. First, the addition of an organic base that had a lower boiling point than that of HFIP was tested. In this test, solid samples were prepared by a pretreatment method under varying conditions, and the solid sample prepared under each condition was analyzed for the state of ester bonds and the state of an acid anhydride structure.

The state of ester bonds was evaluated as decrease in the number of ester bonds by analyzing (quantifying) increase in the number of hydroxy group ends formed through the decomposition of ester bonds in the solid sample by nuclear magnetic resonance (NMR) measurement. More specifically, ¹H NMR (300 MHz) was measured using nuclear magnetic resonance device Oxford from Varian Medical Systems, Inc.

A sample was dissolved in a solvent of deuterated chloroform [containing 0.03% (v/v)Me₄Si] CDCl₃ and 1,1,1,3,3,3-hexafluoro-2-propanol-2d (HFIP-2d) mixed at a volume ratio of 1:1.

Measurement was carried out under a temperature condition of 50° C. For the measurement, the Me₄Si peak of deuterated chloroform [containing 0.03% (v/v)Me₄Si] CDCl₃ was defined as 0 ppm.

Concentration C_{OH} of hydroxy group ends was determined for repeat units from the intensity ratio between the peak of a proton on an aromatic ring δ8.10 ppm) and the peak of a proton on a methylene group at hydroxy group ends δ4.05 ppm) resulting from the decomposition of ester bonds.

The state of an acid anhydride structure was analyzed (quantified) as the presence or absence of a residual acid anhydride structure in a solid sample by infrared spectroscopy (FT-IR). More specifically, measurement was performed by reflection ATR with a single-reflection diamond ATR plate using FT-IR analysis device Frontier Gold manufactured by PerkinElmer, Inc. The residual acid anhydride structure was confirmed from A_{1785/}A₁₀₁₆ wherein the absorbance of 1785 cm⁻¹ (light absorption by the acid anhydride structure) was normalized with the absorbance of 1016 cm⁻¹ (light absorption by an aromatic ring).

ΔA_{1785/}A₁₀₁₆ = (A_{1785/}A₁₀₁₆ when a deteriorated sample is pretreated) - (A₁₇₈₅/A₁₀₁₆ of an undeteriorated sample)

### Sample

Light-deteriorated PET (approximately 10 mg) was used as deteriorated thermoplastic polyester.

### Organic Base

Any of the following organic bases were used.
Isopropylamine (boiling point: 34° C.)
Diethylamine (boiling point: 56° C.)
n-Butylamine (boiling point: 78° C.)
Triethylamine (boiling point: 89° C.)

### Solvent

HFIP (boiling point: 59° C.) and chloroform (boiling point: 61° C.) were used.

### Test 1

In test 1, light-deteriorated PET (10 mg) was dissolved in HFIP (2 mL) (first solution). To this solution, the organic base mentioned above was added at C mmol/L (second solution), followed by warming at 50° C. for 1 h. A small aliquot of this solution (second solution) was collected and subjected to NMR measurement, and “ΔC_{CH2OH} before solvent removal” was calculated. Then, the solvent was removed to obtain a solid sample. The obtained solid sample was subjected to NMR measurement, and “ΔC_{CH2OH} after solvent removal” was calculated. The calculation results are shown in Table 1 below.

Table 1

| Base | C | Δ C_{CH2OH} before solvent removal | Δ C_{CH2OH} after solvent removal |
|---|---|---|---|
| Triethylamine (boiling point 89° C.) | 0.25 | 0 | 2.1 |
| n-Butylamine (boiling point 78° C.) | 0.25 | 0 | 2.5 |
| Diethlamine (boiling point 56° C.) | 0.25 | 0 | 0.2 |
| Isopropylamine (boiling point 34° C.) | 0.05 | 0 | 0.1 |
| | 0.10 | 0 | 0.2 |
| | 0.25 | 0 | 0.3 |
| | 0.30 | 0 | 0.3 |
| | 0.40 | 0 | 0.7 |
| | 0.50 | 0 | 0.7 |

As shown in Table 1, there was neither increase in the number of hydroxy group ends nor the decomposition of ester bonds before removal of the solvent in all the cases. On the other hand, the number of hydroxy group ends was increased after removal of the solvent, demonstrating that the decomposition of ester bonds progressed during the course of removal of the solvent.

### Test 2

In test 2, light-deteriorated PET (10 mg) was dissolved in HFIP (2 mL) (first solution). To this solution, the organic base mentioned above was added at C mmol/L (second solution), followed by warming at 50° C. for 1 h. To this solution (second solution), v mL of chloroform was added, and the mixture was thoroughly stirred (third solution). Then, the obtained solution was heated for the removal of the solvent to obtain a solid sample. The obtained solid sample was subjected to NMR measurement, and “ΔC_{CH2OH} after solvent removal” was calculated. Also, the obtained solid sample was subjected to FT-IR measurement, and “ΔA₁₇₈₅/A₁₀₁₆” was calculated. The results of each calculation are shown in Table 2 below.

Table 2

| Base | C | V | Δ C_{CH2OH} after solvent removal | Δ A₁₇₈₅ / A₁₀₁₆ |
|---|---|---|---|---|
| Triethylamine (boiling point 89° C.) | 0.25 | 0.5 | 0.7 | 0 |
| n-Butylamine (boiling point 78° C.) | 0.25 | 0.5 | 0.5 | 0 |
| Diethylamine (boiling point 56° C.) | 0.25 | 0.5 | 0 | 0 |
| Isopropylamine (boiling point 34° C.) | 0.05 | 0.5 | 0 | 0.12 |
| | 0.10 | 0.5 | 0 | 0 |
| | 0.25 | 0.5 | 0 | 0 |
| | 0.30 | 0.5 | 0 | 0 |
| | 0.40 | 0.5 | 0.1 | 0 |
| | 0.50 | 0.5 | 0.3 | 0 |
| | 0.25 | 0.2 | 0.2 | 0 |
| | 0.25 | 0.3 | 0 | 0 |

As shown in Table 2, for triethylamine and n-butylamine, the number of hydroxy group ends was increased after removal of the solvent, and the decomposition of ester bonds progressed. This is presumably because, since the boiling points of these bases were higher than that of chloroform and HFIP, the concentration and removal of the solvent facilitated elevating the base concentration. For diethylamine and isopropylamine which had a lower boiling point than that of chloroform and HFIP, the number of hydroxy group ends was increased when the amount of the base added was 0.40 mmol/L or more, demonstrating the progression of decomposition of ester bonds. On the other hand, the number of hydroxy group ends was not increased when the amount of these bases added was in the range of 0.10 to 0.30 mmol/L, demonstrating that the decomposition of ester bonds did not progress.

When 0.05 mmol/L of isopropylamine was added, ΔA₁₇₈₅/A₁₀₁₆ > 0 held, demonstrating that when the amount of the organic base added is small, the decomposition of an acid anhydride structure is not completed. When the amount of chloroform added was 0.2 mL, the number of hydroxy groups was increased, demonstrating the decomposition of ester bonds.

From these results, first of all, it was found that an organic base having a lower boiling point than that of chloroform and HFIP is suitable. It was also found that the concentration of the organic base added is suitably 0.05 < c < 0.4. When the amount of HFIP is defined as “a” mL, it is evidently desired that amount V mL of chloroform added should be 0.2 < V. In other words, when the amount of HFIP used in the dissolution of the sample is defined as “a” mL, it is evidently desired that amount V mL of chloroform added should satisfy the relationship of “0.1 < V/a”.

### Experimental results

Hereinafter, results of carrying out the pretreatment method of the present invention and carrying out measurement by size exclusion chromatography will be described. In this experiment, light-deteriorated PET (10 mg) was dissolved in HFIP (2 mL) (first solution). Isopropylamine was added thereto as an organic base at 0.25 mmol/L (second solution), followed by warming at 50° C. for 1 h. Then, 0.5 mL of chloroform was added thereto, and the mixture was thoroughly stirred (third solution). The obtained solution was heated for the removal of the solvent to obtain a solid sample. The obtained solid sample was measured by size exclusion chromatography.

### Measurement equipment

For measurement, SEC device AQUICTY APC from Waters Corp. was used. Also, APC-XT, 186006995, 186006998, 186007003, and 186007254 were used as columns.

### Standard sample

Six types of commercially available polymethyl methacrylate (PMMA) standard samples having a peak top molecular weight of 102500, 56900, 24400, 10900, 8350, or 4250 were used to carry out measurement. A triple calibration curve was prepared.

### Sample preparation

The solid sample obtained by pretreatment was dissolved at 1 mg/1 mL in an eluent of HFIP containing 10 mmol/L of sodium trifluoroacetate. A sample bottle of the obtained solution was capped and left standing overnight. The sample was added to a vial for measurement, filtered through a PTFE syringe filter having a pore size of 0.2 µm, and subjected to measurement.

### Measurement conditions

Eluent: HFIP containing 10 mmol/L of sodium trifluoroacetate
Column temperature: 40° C.
Flow rate: 0.25 mL/min
Sample concentration: 1 mg/mL
Injection volume: 0.2 µL/run
Detector: RI detector (40° C.)

The measurement results are shown in FIG. 3. In FIG. 3, line 201 depicts results of measuring undeteriorated PET without pretreatment. Line 202 depicts results of measuring an undeteriorated PET pretreated according to the present invention. Line 203 depicts results of measuring light-deteriorated PET without pretreatment. Line 204 depicts results of measuring light-deteriorated PET pretreated according to the present invention.

As described above, according to the present invention, the decomposition of ester bonds can be suppressed in the pretreatment of a sample consisting of polyester or a polyester decomposition product for carrying out size exclusion chromatography, because an organic base that has a lower boiling point than that of HFIP is added.

The present invention is not limited by the embodiments described above. It is obvious that those ordinarily skilled in the art are capable of carrying out many modifications and combinations without departing from the technical brief of the present invention.

### REFERENCE SIGNS LIST

101 Molecular chain
102 Acid anhydride structure
103 Cross-linked structure
201,202,203,204 Line

1. -5. (canceled)

6. A method for pretreating a sample comprising polyester or a polyester decomposition product before carrying out size exclusion chromatography of the sample, the method comprising:
dissolving the sample in 1,1,1,3,3,3-hexafluoro-2-propanol to prepare a first solution;
adding an organic base that has a lower boiling point than that of the 1,1,1,3,3,3-hexafluoro-2-propanol to the first solution to prepare a second solution;
heating the second solution to obtain a substance in which an anhydrous oxide structure in the sample has been decomposed;
after heating the second solution, adding chloroform to the second solution to prepare a third solution; and
removing the chloroform from the third solution to obtain a solid sample consisting of the substance.

7. The method according to claim 6, further comprising dissolving the solid sample in a solvent for the size exclusion chromatography.

8. The method according to claim 6, wherein a concentration of the organic base in the first solution is greater than 0.05 [mmol/L] and less than 0.4 [mmol/L].

9. The method according to claim 6, wherein a ratio of amount V [mL] of chloroform to amount “a” [ml] of the 1,1,3,3,3-hexafluoro-2-propanol in the third solution is 0.1 < V/a.

10. The method according to claim 6, wherein the organic base comprises any of ethylamine, n-propylamine, i-propylamine, t-butylamine, diethylamine, or dimethylethylamine.

11. A pretreatment method comprising:
preparing a first solution by dissolving a sample comprising polyester or a polyester decomposition product in 1,1,1,3,3,3-hexafluoro-2-propanol;
preparing a second solution by adding an organic base that has a lower boiling point than that of the 1,1,1,3,3,3-hexafluoro-2-propanol to the first solution, wherein a concentration of the organic base in the first solution is greater than 0.05 [mmol/L] and less than 0.4 [mmol/L];
obtaining a substance in which an anhydrous oxide structure in the sample has been decomposed by heating the second solution;
after obtaining the substance, preparing a third solution by adding chloroform to the second solution;
obtaining a solid sample consisting of the substance by removing the chloroform from the third solution; and
dissolving the solid sample in a solvent for size exclusion chromatography.

12. The pretreatment method according to claim 11, wherein a ratio of amount V [mL] of chloroform to amount “a” [ml] of the 1,1,3,3,3-hexafluoro-2-propanol in the third solution is 0.1 < V/a.

13. The pretreatment method according to claim 11, wherein the organic base comprises any of ethylamine, n-propylamine, i-propylamine, t-butylamine, diethylamine, or dimethylethylamine.
